(19) United States
(12) Patent Application Publication
(10) Pub. No.: US 2003/0160173 A1
(43) Pub. Date: Aug. 28, 2003

(54) Remote gas molecule detector

(76) Inventors: Oleg Ershov, Moscow (RU); Alexander Nadezdinskii, Moscow (RU); Andrey Berezin, Moscow (RU)

Correspondence Address: David W. Carstens, PO Box 802334, Dallas, TX, 75380-2334, US

(21) Appl. No.: 10/080,486

(22) Filed: Feb. 22, 2002

(51) Int. Cl. G01N 21/35

(52) U.S. Cl. 250/338.5

(57) ABSTRACT

The present invention provides a system and an apparatus for remotely detecting a gas molecule. The apparatus includes a diode laser for emitting radiation at a maximum absorption band of the gas molecule to be detected and a single mode fiber connected to the diode laser for narrowing spatial inhomogeneous of the radiation. The intensity of the laser diode depends on amount of the feeding current. Laser diode's temperature is stabilized by a thernistor and peltier element. The current feeding into the pump current adjusts and stabilizes the temperature of the diode laser. After going through an optical scheme, the radiation may be absorbed by the present gas molecule. The photodetector will detect whether absorption has occurred or not. This type of detection is utilized in detecting alcohol molecule in an enclosure such as a vehicle.

### BACKGROUND OF THE INVENTION

1. Technical Field

The present invention relates to a gas molecule detector. More specifically the invention relates to a laser device for detecting the presence of alcohol molecules from a distance. The device is controlled by a computer system.

2. Description of the Related Art

The colors of an object typically arise because materials selectively absorb light of certain frequency, while scattering or transmitting light of other frequencies. For example an object is red (wavelength range from 6300 and 6800 Å) if it absorbs all visible frequencies except those our eyes perceive to be “red.” Thus, we see the scattered wavelength range from 6300 and 6800 Å from that object.

Similarly, gas molecules absorb at different frequencies. A predefined range of wavelength propagating through gas molecules are absorbed at the resonance frequencies of the atoms or molecules, so that one observes gaps in the wavelength distribution of the emerging wavelengths. Absorption lines of a gas molecule have its own intensity and spectral position. For example, absorption spectrum of simple molecule gas consists of narrow, isolated spectral lines. Alcohol (ethanol) like other complex organic molecule has spectrum that consists of many overlapping lines. Alcohol molecule has rather broad spectra about 100 times broader than isolated spectral line of a simple molecule. Selecting an alcohol spectrum for detecting the presence of its molecule can be complicate. The strongest and sharpest feature of ethanol absorption spectrum in near infrared range (1.387-1.414 μm) is Q-branch with maximum from 1.3924-1.3935 μm. On the other hand, the high intensity of absorption lines exists in mid infrared range (3-10 μm). In the present invention, the spectrum near 1.392 μm is preferred over mid infrared range because of the following principal:

1. This spectral range is not hazardous for eyes if power of light sources is not more than 1 mW.

2. Glass windows are transparent in this range.

Traditionally, gas molecule detectors utilize infrared spectroscopy to detect the specified gas including alcohol. This type of detection requires complicated optical filters. The accuracy of detection depends on the sensitivity of these filters. Filter may detect more than one type of gas molecules where interference is highly probable.

### SUMMARY OF THE INVENTION

The present invention provides for a more sensitive detection of gas molecules without the use of optical filters by using laser technology, thereby eliminating interference from other gas molecules.

An embodiment of the present invention utilized diode laser (“DL”) for alcohol detection because the radiation bandwidth is 10⁻³ cm⁻¹. In laser diode, radiation is produced by the recombination of electrons and holes at a pn junction (semiconductor). A laser diode is small in size like other semiconductor devices. Its output can be modulated by varying the current.

Diode lasers usually do not employ mirrors for feedback. This is because the refractive index is large enough to give considerable reflection at the semiconductor/air interface. Diode laser allows for fast scanning of the radiation frequency, so measurements are produced simultaneously in a predetermined wavelength range. It allows accounting of specific features of alcohol absorption band, that is important for selective measurements. Special improvements were made in the alcohol detector for subtracting of humidity variations, because water vapor absorption in used wavelength range is rather high. Special improvements were made in present invention for subtracting of various disturbances due to accidental sun illumination, vehicle window curvature and dirt on their surfaces, optomechanic vibrations. With the employment of diode laser, the improved alcohol detector is low cost and small and compact.

### BRIEF DESCRIPTION OF THE DRAWINGS

FIG. 1 is a block diagram of an alcohol detector of according to an embodiment of the present invention.

FIG. 2 is a block diagram of an alcohol detector system according to an embodiment of the present invention.

FIG. 3 is a block diagram of a computer system in accordance with an embodiment of the present invention.

FIG. 4 is a pictorial representation of an alcohol detector controller in accordance with an embodiment of the present invention.

FIG. 5 is a pictorial representation of interface module in accordance with an embodiment of the invention.

FIG. 5(a) is a DL current supply in accordance with an embodiment of the present invention.

FIG. 5(b) is a resistance-voltage transformer in accordance with an embodiment of the present invention.

FIG. 5(c) is a peltier supply in accordance with an embodiment of the present invention.

FIG. 6 is a pictorial representation of a photodetector transformer/amplifier unit in accordance with an embodiment of the invention.

FIG. 7 is a block diagram of software in accordance with an embodiment of the invention.

FIG. 8 is a flowchart of signal processing in accordance with an embodiment of the invention.

FIG. 8(a) is a graph of DL current corresponding to point number in accordance with an embodiment of the present invention.

FIG. 8(b) is a graph of [DL current corresponding to point number] in accordance with an embodiment of the present invention.

FIG. 9 is a flowchart for calculation of alcohol concentration in accordance with an embodiment of the present invention.

FIG. 9(a) is a graph of water and alcohol absorption factors corresponding to the wavelength in accordance with an embodiment of the present invention.

FIG. 10 is a flowchart for DL temperature stabilization in accordance with an embodiment of the present invention.

### DETAILED DESCRIPTION

The description of the preferred embodiment of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention the practical application to enable others of ordinary skill in the art to understand the invention for various embodiments with various modifications as are suited to the particular use contemplated.

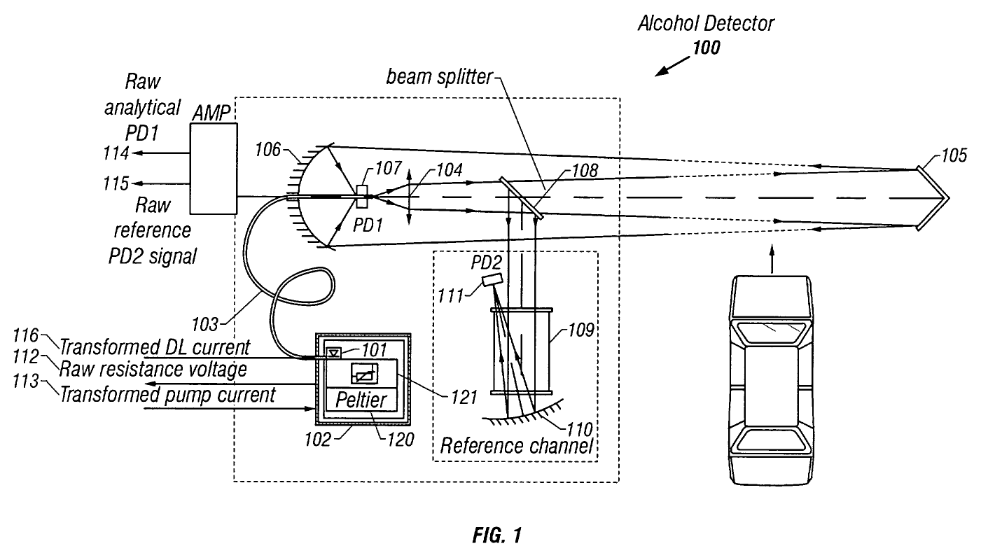

With reference now to the figures and in particular with reference to FIG. 1, a pictorial representation of alcohol detector 100 in accordance with an embodiment of the present invention is illustrated. Alcohol detector 100 involves diode laser (“DL”) 101 assembled with peltier element 120 and thermistor 121, a temperature sensitive resistor. Diode laser 101 radiating power is proportional to transformed DL current 116. Diode laser 101 wavelength depends on the temperature of the diode laser 101 from 1.3906 urn at 0° C. to 1.3933 urn at 40° C. um. Peltier element 120 and thermistor 121 assist in adjusting and stabilizing the temperature of diode laser 101 such that the emitted wavelength stays near alcohol absorption band at 1.392 um. Initially, thermistor 121 sets the temperature for diode laser 101 with the raw resistance voltage 112. Peltier element 120 controls the temperature either by removing the heat by pumping heat away from the chamber adjacent to a device or adding heat to that chamber. In this case, the greater, the transformed pump current 113, the more heat is removed from the chamber adjacent to diode laser 101, thereby cooling it. In a preferred embodiment of the present invention, such assembly of diode laser, peltier element, and thermistor is commercially available from Sensors Unlimited, Inc. with part number, SU1393-DFB-TE. Moreover, peltier element 120 and thermistor 121 can be substituted by other temperature stabilizing components. Diode laser 101, peltier element 120 and thermistor 121 are housed inside thermostatic enclosure 102. Thermostatic enclosure 102 helps to keep the temperature of the assembly constant without the effect of the changing temperature of the outside environment. Outside of thermostatic enclosure 102, the alcohol detector further includes optical components for analytical optical scheme and for reference optical scheme.

In the analytical optical scheme, diode laser 102 radiation is channeled into a single mode fiber 103 of about two meters long. Single mode fiber 103 narrows or diminishes the concentration of radiation in which the inhomogenity of DL radiation is 0.3%. At various pumping current values, radiation is generated by different regions of the diode laser active area with different directional patterns and radiating power. As a result, the cumulative dependence of radiating power on pumping current varies for different angles of DL radiation pattern. In the used DL radiation pulse mode when radiation frequency is scanned by current within a pulse, the pulse shape of a photoreceiver signal varies depending on a part of DL radiation pattern falling on a photoreceiver platform. It turned out that the homogeneous laser radiation pattern can be most effectively obtained using a single mode optical fiber with 7 um diameter of central part. DL radiation transmitted through the fiber˜2m long results in the highly homogeneous radiation pattern at the fibre exit. The output of the single mode fiber 103 is diverged at a 10° angle obeying the Gaussian law.

Then the radiation is passed through objective 104 to be adjusted by refraction in order to fully illuminates the cube reflector 105. Between objective 104 and reflector 105, the radiation may have pass through an enclosure, for example, a moving vehicle on the road with alcohol molecules within the enclosure. The absorption of the alcohol molecules occurs for the first time. In a preferred embodiment of the present invention, alcohol molecules may be detected here. The reflected radiation fully illuminates spherical mirror 106 having a 6.5 cm diameter, which is positioned behind objective 104. The optical path between reflector 105 and spherical mirror 106 undergoes a second absorption of the alcohol molecules inside the enclosure. Because radiation passes through the enclosure twice, the absorption of the alcohol molecules amplifies. Spherical mirror 106 focuses the absorbed radiation on the sensing area of analytical photodetector 107. Then, photodetector 107 generates raw analytical PD1 signal 114.

In the reference optical scheme, splitter 108 generates a reference radiation. Splitter 108 is positioned after objective 104. The reference radiation passes through reference cell 109 having a predetermined concentration of water molecules. Next, the reference radiation is reflected by spherical mirror 110 to pass through the reference cell 109 again before reaching the sensing area of reference photodetector 111. Reference photodetector 111 generates raw reference PD2 signal 115. In a preferred embodiment, radiation is ready for detection when the reference radiation passes once through reference cell 109. Photodetectors 107 and 111 of the Alcohol detector are Germanium photodiodes with sensing area near 2 mm² and Noise Equivalent Power (NEP) 10⁻¹¹ W/Hz^{1/2}.

Those of ordinary skill in the art will appreciate that the detector is capable of detecting alcohol or other gas molecules. This detailed description specifically describes alcohol molecules, which may be substituted by other detectable gas molecules having distinct absorption band. The diode laser may emit radiation according to the gas molecule absorption band. The reference cell's content may differ. The depicted example is not meant to imply molecule limitation with respect to the present invention.

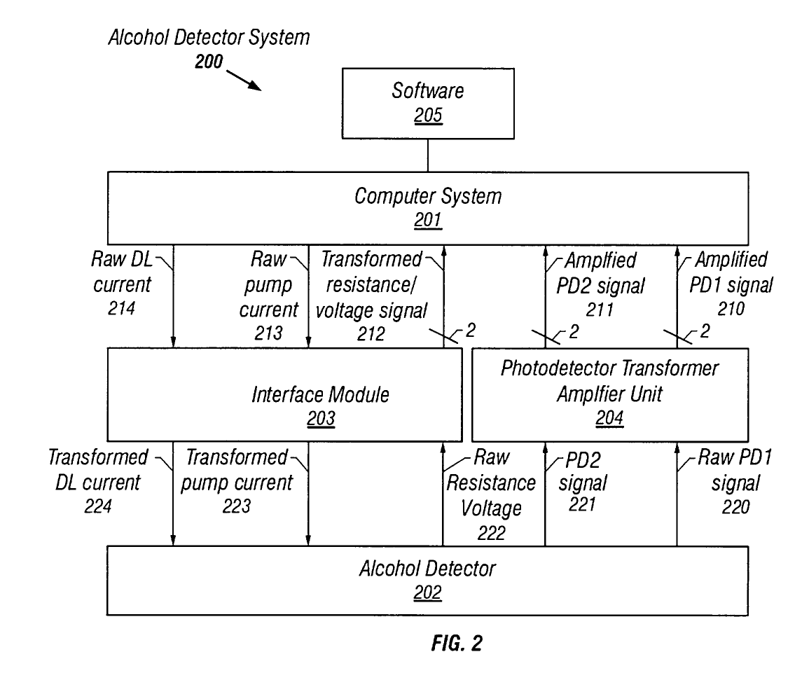

Referring now to FIG. 2, a block diagram of an alcohol detector system is shown in accordance with a preferred embodiment of the present invention. Alcohol detector system 200 includes computer system 201, alcohol detector 202, interface module 203, photodetector transformer amplifier unit 204, and software 205. Software 205 initializes and synchronizes alcohol detector system 200. It also provides for alcohol detector system signal processing and storing and analyzing data. Computer system 201 provides processing and control to alcohol detector system 200. There are five signals communicating between computer system 201 and alcohol detector 202. These signals must pass through either interface module 203 or photodetector transformer amplifier unit 204. Computer system 201 receives three data inputs; amplified PD1 signal 210 and amplified PD2 signal 211 from photodetector transformer amplifier unit 204 and transformed resistance/voltage signal 212 from interface module 203. These inputs are differential lines. Computer system 201 transmits two outputs, raw diode laser current 213 and raw pump current 214 to interface module 203.

On the other end of interface module 203 and photodetector transformer amplifier unit 204, alcohol detector 202 transmits three data signals, raw PD1 signal 220 and raw PD2 signal 221 to photodetector transformer amplifier unit 204 and raw resistance voltage 222 from interface module 203. Alcohol detector 202 receives two inputs, transformed tunable current 224 and transformed Pump current to interface module 223.

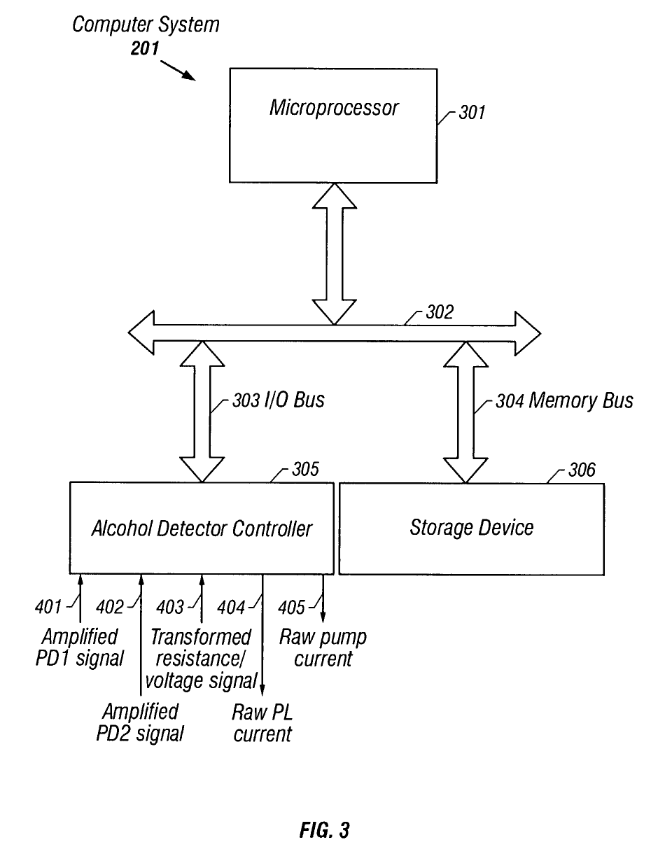

Referring now to FIG. 3, a block diagram of a computer system 201 is shown in accordance with a preferred embodiment of the present invention. Computer system 201 may employ a single microprocessor 301, or in the alternative, multiple microprocessors on the system bus 302. A storage device is connected to a memory bus 304. An input/output (“I/O”) device may be integrated to the I/O bus 303 as depicted. A storage device includes memory devices such as hard disk drive 306. I/O device includes an alcohol detector controller 305 for assisting in the control of an alcohol detector. Computer system 201 controls and communicates with the alcohol detector.

Those of ordinary skill in the art will appreciate that the hardware depicted in FIG. 3 may comprise of multiple microprocessors, multiple storage devices, or multiple I/O devices. These devices may vary. For example, other peripheral devices, such as optical disk drives and the like, also may be used in addition to or in place of the hardware depicted. The depicted example is not meant to imply architectural limitations with respect to the present invention.

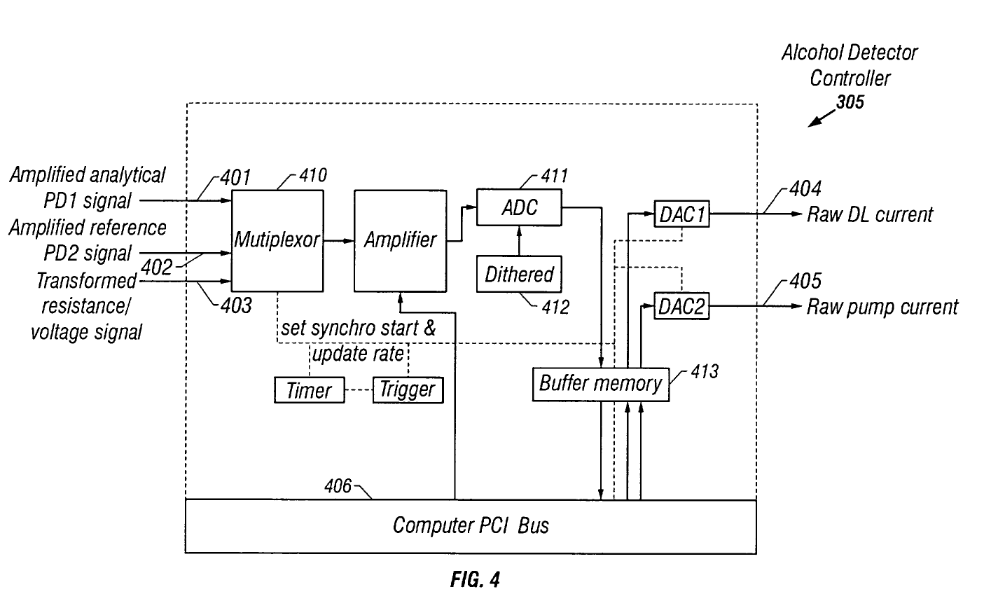

Referring now to FIG. 4, a block diagram of an alcohol detector controller 305 is illustrated. Controller 305 involves three inputs and two analog outputs interfacing the alcohol detector 305 and a computer PCI bus. Controller 305 receives amplified analytical PD1 signal 401 amplified reference PD2 signal 402. Controller 305 also receives transformed resistance/voltage signal 403. Transformed resistance/voltage signal 403 is multiplexed with amplified analytical PD1 signal 401 and amplified reference PD2 signal 402. A multiplexor 410 allows successive connecting of inputs to analog to digital converter (“ADC”) 411 with set update rate, which value can't exceed a predetermined sampling frequency, 1.25 MHz. Next, dither 412 may be used for smoothing of bits in ADC 411 output signals. A timer controlled by software serves as clock cycle for alcohol detector controller 305. It may include a frequency divider that allows for frequency adjustments of output signal generation and data acquisition. A trigger is controlled by the timer. It serves as a synchronizational signal for the signal generation and data acquisition. If this triggering synchronization switches at a common frequency, it creates an operational frequency for the alcohol detector controller 305.

With regards to controller's outputs, data are stored in buffer memory 413. A predetermined pulsed signal for DL current pulse is stored in buffer memory 413 for DL current. The data stored in the buffer memory 413 flows to the first digital-to-analog converter (“DAC1”). DAC1 supplies continuous train of raw DL current 404. Pump current for the peltier element must be calculated by the computer system. Then pump current data is transferred and stored in buffer memory 413 in which it flows to the second digital-to-analog converter (“DAC2”). DAC2 supplies continuous train of raw pump current 405. Controller 305 is installed in the computer PCI bus 406 and connected with Interface module and photodetector transformer/amplifier unit. Data exchange between controller 305 and computer through reads and writes of controller's 305 buffer memory 413. In a preferred embodiment of the present invention, controller 305 is configured from a standard multifunctional NI-DAQ board of the PCI-MIO-16E-1 produced by National Instruments, Inc.

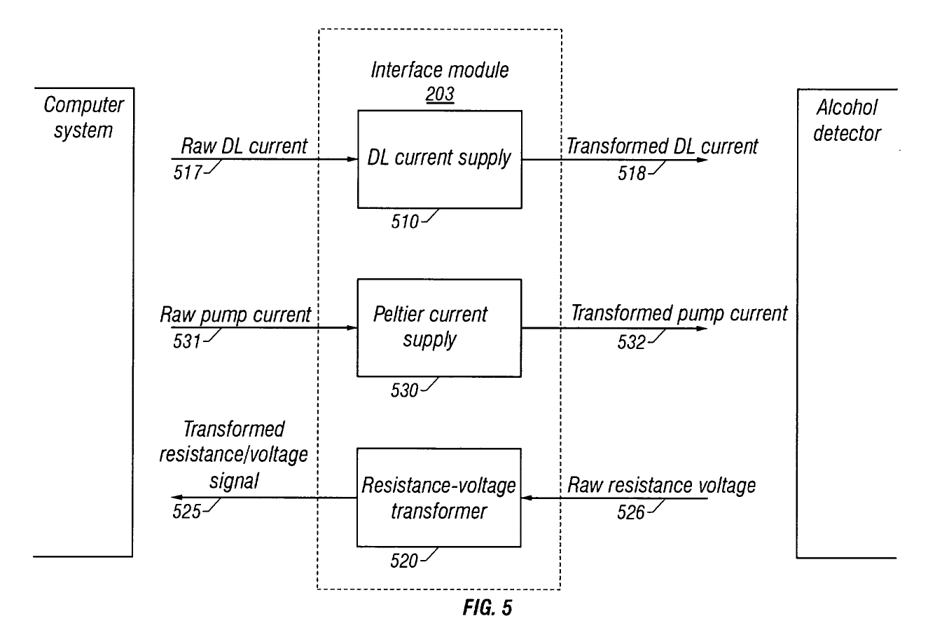

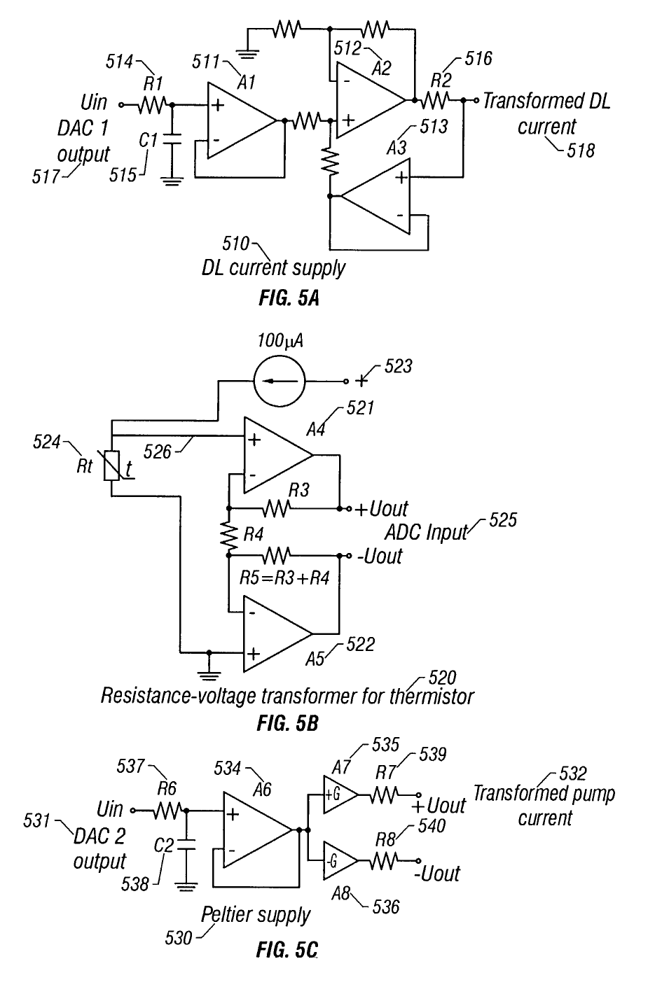

Referring now to FIG. 5, a pictorial representation of interface module 203 in accordance with an embodiment of the present invention is illustrated. Interface module 203 involves three analog units: DL current supply 510, resistance-voltage transformer 520, and peltier current supply 530. Interface module 203 provides interface for three signals between the alcohol detector 100 and alcohol detector controller 305. In FIG. 5(a), DL current supply 510 amplifies and transforms the pulse of raw DL current 517 into pulses of amplified DL current 518 feeding alcohol detector. It includes three operational amplifiers, 511-513. Resistance R1 514 and capacitance Cl 515 define frequency bandwidth. Resistance R2 516 defines the current/voltage transformation factor. The output operational amplifier A₂ 513 and resistor R₂ 516 are chosen thermo stable for preventing drift of output parameters.

Two other units of interface module 203, resistance-voltage transformer 520 and Peltier current supply 530, are intended for stabilizing and adjusting the diode laser temperature. The temperature of thermistor having good thermal contact with diode laser in alcohol detector 100 is measured in the Resistance/Voltage Transformer unit 520 as depicted in FIG. 5(b). Resistance-voltage transformer unit 520 includes two operational amplifiers 521 and 522 and stable current supply 523. Current supply 523 ensures that a current of 100 uA flows the thermistor R₁ 524. Resistance-voltage transformer unit 520 transforms raw resistance-voltage signal 526 into a voltage value for transformed resistance-voltage signal 525. Transformed resistance-voltage signal 525 transmits to Controller 305 as one of the inputs, which is later transformed into degree value in the device software.

In FIG. 5(c), the raw pump current 531 from alcohol detector controller 100 is transmitted to Peltier current supply 530 of the Interface module 203. Peltier current supply 530 constitutes a power amplifier for supplying differential voltage for transformed pump current 532. The unit includes three operational amplifiers, 534-536, resistance R₆ 537 and capacitance C₂ 538 restrict frequency bandwidth, resistances R₇ 539 and R₈ 540 restrict maximum output current for transformed pump current 532. All units of the Interface module 203 are storage battery-powered; the batteries being very stable sources. Such independent power supply ensures stable operation and high values of a signal to noise ratio.

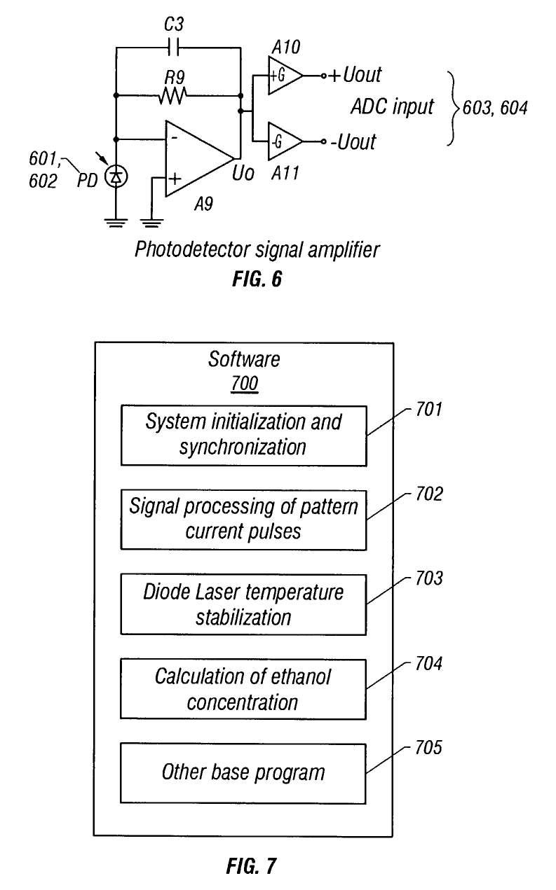

Referring now to FIG. 6, a pictorial representation of a photodetector transformer/amplifier unit 204 in accordance with an embodiment of the present invention is illustrated. Photodetector transformer/amplifier unit 204 transforms raw analytical PD1 signal 601 and raw reference PD2 signal 602 respectively into differential amplified analytical PD1 signal 603 and amplified reference PD2 signal 604. Amplified analytical PD1 signal 603 and amplified reference PD2 signal 604 are inputs of Alcohol Detector Controller 305. Base scheme of these transformer-amplifiers is shown at FIG. 6. The first stage of the scheme is typical transimpedance amplifier A9 where R9 and C3 are feedback resistance and capacitance respectively. Amplifier frequency bandwidth is defined by capacitance C3, transfer factor at low frequencies is defined by resistance R9. Second stage of the scheme is voltage amplifiers A10 and A11 for generating differential outputs. Photodetector transformer/amplifier unit 204 is also battery-powered for providing high signal to noise ratio.

Referring now to FIG. 7, a block diagram of software 205 in accordance with an embodiment of the present invention is illustrated. Software 701 initializes and synchronizes alcohol detector system 200. It also provides for alcohol detector system computer program instruction for signal processing 702, diode laser temperature stabilization 703, calculation of alcohol concentration 704 and other operations are produced in the base part of the program 705.

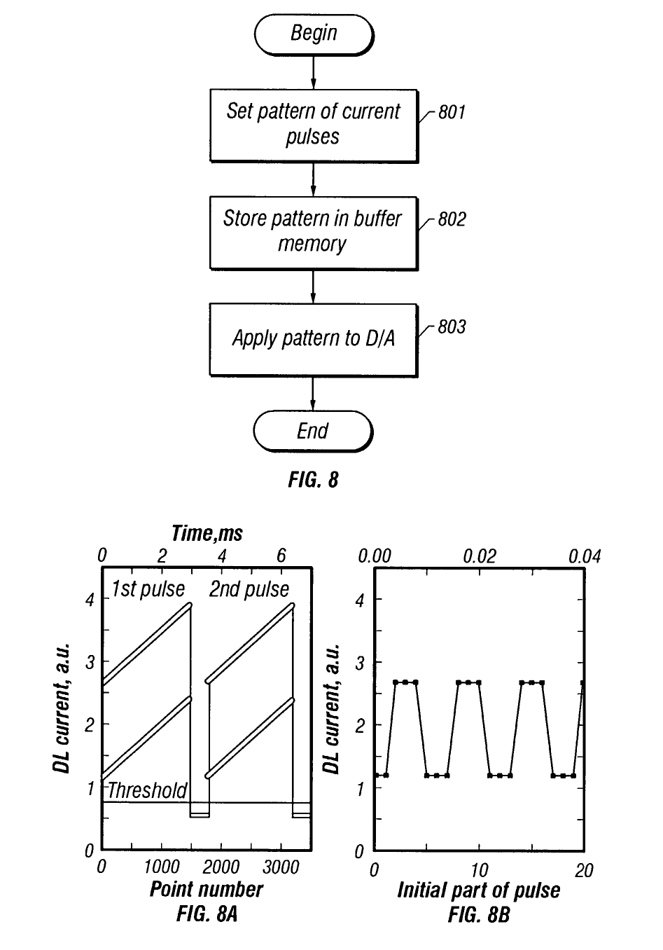

Referring now to FIG. 8, a flowchart of signal processing 702 according to an embodiment of the present invention is illustrated. The software provides instructions for signal processing for generating the pattern of pulses of DL current (step 801). The pulse pattern period must in proportionate to the digital to analog converter update rate. The pattern is then stored in the alcohol detection controller's buffer memory (step 802). The software further provides instructions for applying the pattern to the alcohol detection controller's digital to analog converter (step 803). In a preferred embodiment of the present invention, the pulse period is 3.6 ms with 0.85 duty factor. Therefore, the pulse is above the threshold current for 3.0 ms, and below the threshold current for 0.6 ms. The DAC's update rate is 500 kHz. Thus, in order to generate a pulse period, the signal processing 702 must generate 1800 points to be store in the buffer memory. Of the 1800 points, 1500 points is for generating current above the threshold level and 300 points for below. A graph of raw DL current with point number is depicted in FIG. 8(a).

Current pulse is high frequency square modulated with rather high modulation amplitude. If the controller update rate equals 500 kHz, the modulation period equals 12 us, so each period includes 6 points: three points at higher amplitude, three points at lower amplitude and so on. See FIG. 8(b). As a result each pulse is divided in two branches: upper and lower. Each branch in the pulse is of trapezoid form with the same slope. So DL radiation wavelength is swept in each branch in different ranges. For ethanol detection the ranges of scanning diode laser radiation wavelength were chosen the following: 1.39262 urn-1.39284 urn for lower branch and 1.39262 urn-1.39274 urn for upper branch. The DAC in the alcohol detector controller, transform the pulsed pattern into a continuous raw DL current.

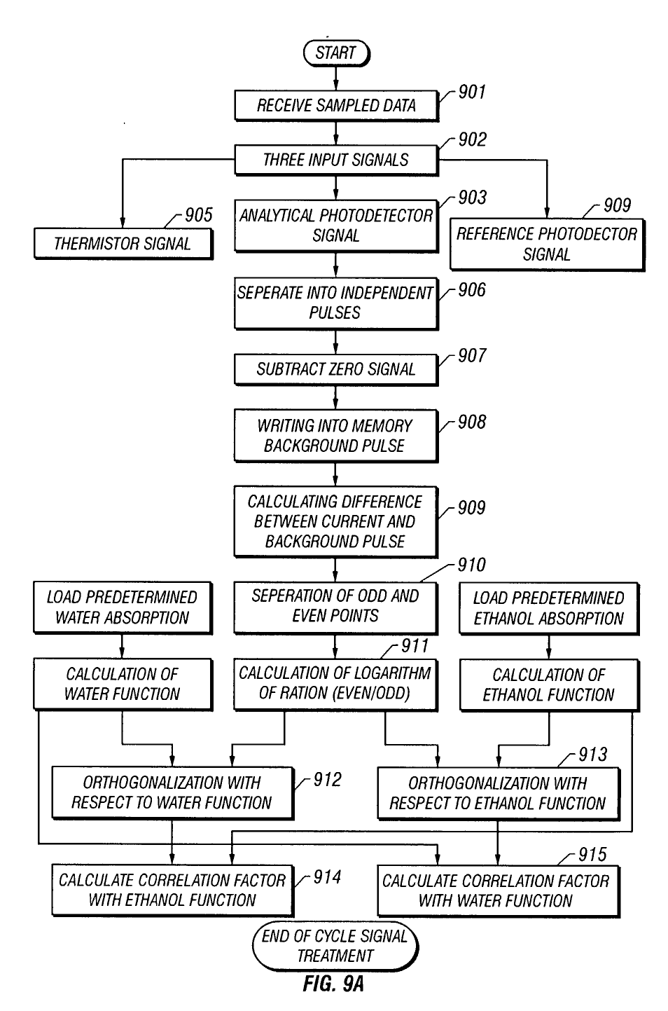

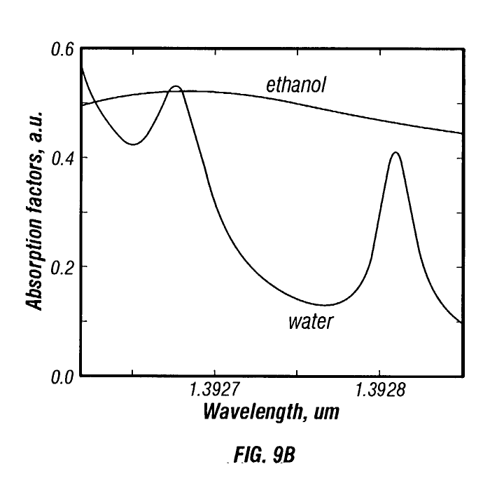

Referring now to FIG. 9, a flowchart for calculation of alcohol concentration 704 according to an embodiment of the present invention is illustrated. The process for calculating alcohol concentration starts with the receipt of sampled data from the analytical photodetector signal at beginning of the current pulse (step 901).

Three controller inputs (step 902): (1) photodetector signal from analytical channel (step 903), (2) photodetector signal from reference channel (step 904), (3) signal proportional to thermistor resistance (step 905), are used in present invention. They are applied to the controller ADC successively, so sampling frequency of each input is three times lower than the controller update rate and equals 166.6 kHz. Pulse duration in photodetector signals includes 500 points, duration between adjacent pulses includes 100 points, and pulse repetition period includes 600 points. Modulation period in the signals is two times more than duration between adjacent points; so even points form one branch (low), odd points form another branch (high).

The first channel contains sampled analytical PD1 signals made up of a train of pulses having 3.6 ms period (step 903). The software separates the pulses for independent treatment of each pulse (step 906) according to a period or cycle of a pulse. In step 907, the value of “zero signal” between two pulses is subtracted from each of the points respectively. “Zero signal” is PD signal when laser is switched off. This signal includes photodetector preamplifier output shift and value connected with illumination of photodetector by other light sources. The value of zero signal is averaged by 100 points between two adjacent pulses. Step 907 lessens interference of photodetector illuminated by another sources (i.e. light illumination reflected by pieces of glass or car windows). The result from subtracting zero signal is saved as background pulse (step 908). Next the process calculates the difference between the background pulse and the raw current (step 909). The independent pulse is further separated into two arrays: (a) an odd array for storing all the odd points; and (b) an even array for storing all the even points (step 910). Another procedure for lessening interference, in step 911, is calculating the logarithm of the ratio of respective even point over odd point (e.g. Ln(even/odd)). Logarithm value is proportional to the difference of absorptions at the branches wavelength ranges and would lessen any low-frequency signal interference from mechanical vibration or interfering illumination.

The predetermined Fourier Transform is stored in memory and accessible by the system. Unique features of absorption spectrum of alcohol and water in the range of wavelength scanning are used for their detection. FIG. 9(a) shows the predetermined absorption lines of alcohol and water at wavelength range around 1.39268 um. The calculated concentration of water (content in the reference cell) and alcohol is distinguished from each other by mutual orthogonalization of the correlated factors of alcohol and water (steps 912 and 913) e.g. gas molecules to be detected and the content in the reference cell. In a preferred embodiment of the present invention, X denotes input processed signal (in this case, it is Ln(even/odd)), A denotes alcohol function (difference of alcohol absorption factors in the wavelength ranges corresponding to upper and lower parts of laser radiation), and W denotes water function. X, A, and W are one-dimensional arrays or vectors. The number of values in these arrays equals to (pulse point number)/2. For our parameters this number is equal to 300. Orthogonalization of X with respect to water is:

X_{w}=X−(X*W)*W/(W*W),

where (a*b) is scalar product of two vectors. Accordingly orthogonalization with respect to alcohol is:

Xₐ=X−(X*A)*A/(A*A).

The calculation of correlation factors may be produced after orthogonalization. Correlation factor of orthogonalized signal and alcohol function is: a=(X_{w}*A), this value for water function is: w=(Xₐ*W) in which a is proportional to ethanol concentration, and w is proportional to water concentration.

Lastly, the concentration of water and alcohol is calculated by correlating the arrays with the predetermined absorption functions of alcohol and water (steps 914 and 915).

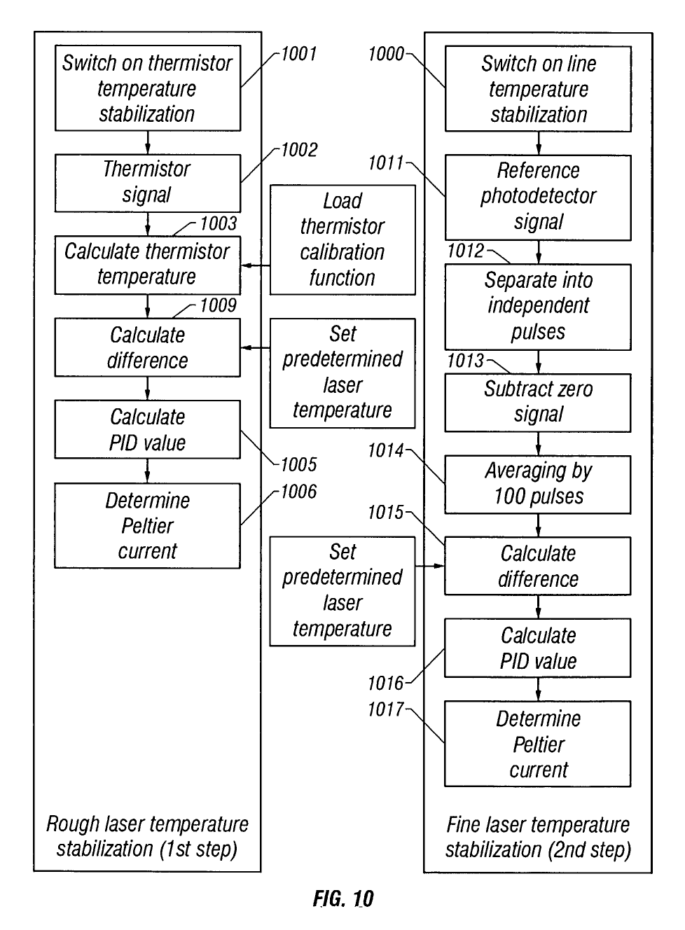

Referring now to FIG. 10, a flowchart for DL temperature stabilization 703 according to an embodiment of the present invention is illustrated. Initially, the diode laser's temperature is set with the help of the thermistor (step 1001). First the process receives the transformed resistance/voltage signal (step 1002) from thermistor. With a predetermined load thermistor calibration function, the thermistor's actual temperature can be calculated (step 1003). Then with a set predetermined laser temperature and thermistor's actual temperature, the process calculates the temperature difference (step 1004). Next, the process calculates the PID (Proportion, Integral, Derivative) value (step 1005) in order to determine the pump current (step 1006). Initially, the diode laser and thermistor should have the same temperature until the diode laser generates more heat in which the temperature of the two components differs. As a result, thermistor's temperature is stabilized and not the diode laser. After the initial setting of the temperature, the process switches to line stabilization position (step 1010) for stabilizing DL temperature. The absorption line position within a recorded pulse is an unbiased criterion of DL true temperature. First, it receives the sampled data from amplified reference PD2 signal (step 1011). Each pulse is separated from the other (step 1012) for subtraction from zero signal (step 1013). The process repeats step 1013 one hundred times (100×) for one hundred pulse period before it takes the average value (step 1014). Next, with a preferred predetermined laser temperature and the calculated average value, the temperature difference is calculated (step 1015). Then the PID value must be calculated (step 1016) before the determination of pump current (step 1017). The difference between current absorption line position and predetermined one come to the input of PID (Proportion, Integral, Derivative) program module. Value from output of this module is applied to DAC 2 for feeding Peltier element. This value at n step of the program cycle (Vₙ) is calculated in conformity with formula:

Vₙ=a*Pₙ+b*Iₙ+c*Dₙ

where Pₙ is the difference (see above) at n step of the program cycle,

$${I}_{n} = {\sum }_{0}^{n} {P}_{1} ,$$

Dn=Pₙ−Pₙ₋₁, a, b, c-factors.

Because Pump current is not constant and must be determined, Pump current is tunable and directly stabilizes DL temperature. The determined Pump current is applied DAC2 on the controller in which the Pump current is made continuous before channeling to the interface module. DL temperature variations directly affect the DL radiation wavelength variation. The stabilization of DL temperature ensures that DL will operate in the stable range near the maximum alcohol absorption band at 1.39268 um.

Although preferred embodiments of the present invention have been described in the foregoing Detailed Description and illustrated in the accompanying drawings for alcohol detection, it will be understood that the invention is not limited to the embodiments disclosed, but is capable of detecting other gas molecules which may require numerous rearrangements, modifications, and substitutions of steps without departing from the spirit of the invention. For example, each gas molecule having distinct absorption band would require a diode laser radiating at or near that band, the photodetector functions at the distinct absorption band, the predetermined DL current may differ in the sampled points and duration, the reference cell may differ in content. etc. Accordingly, the present invention is intended to encompass such rearrangements, modifications, and substitutions of steps as fall within the scope of the appended claims.

We claim:

1. An apparatus for remotely detecting a gas molecule comprising:
a diode laser for emitting radiation at a maximum absorption band of said gas molecule wherein said radiation is tunable by adjusting the temperature of said diode laser; and
a single mode fiber coupling to said diode laser for diminishing of spatial inhomogenity of said radiation.

2. The apparatus as recited in claim 1 wherein said gas molecule detector detects alcohol molecules.

3. The apparatus as recited in claim 2 wherein said diode laser emits radiation near 1.392 um.

4. The apparatus as recited in claim 1 wherein said gas molecule detector further comprises:
a first connection for a first current into the diode laser; and
a second connection for a second current adjusting the temperature of the diode laser.

5. The apparatus as recited in claim 4 wherein said first current is a pulse with 3.6 ms period.

6. The apparatus as recited in claim 4 wherein said second current is tunable for a maximum absorption band of said gas molecule.

7. The apparatus as recited in claim 6 wherein said gas molecule is alcohol with an absorption band with Q-branch from 1.3924-1.3935 um.

8. The apparatus as recited in claim 1 wherein said gas molecule detector further comprises:
an optical splitter receiving the emitted radiation and producing a first and second optical channels;
a first detector detecting the presence of said gas molecule from the first optical channel; and
a second detector for reference from the second optical channel.

9. The apparatus as recited in claim 8 wherein said first detector detects the presence of alcohol molecules.

10. The apparatus as recited in claim 8 wherein said second detector provides absorption reference of the content in a cell.

11. The apparatus as recited in claim 10 wherein said cell contains a predetermine gas content.

12. The apparatus as recited in claim 10 wherein said cell contains a predetermine water content.

13. The apparatus as recited in claim 8 wherein said first optical channel capable of passing twice through an enclosure to be detected of said gas molecule, whereby the absorption of the gas molecule is amplified.

14. The apparatus as recited in claim 8 wherein said second optical channel capable of passing twice through a cell having a predetermined second gas molecule content, whereby the absorption of said second gas molecule is amplified.

15. A computer system for controlling a remote gas molecule detector, said computer system comprising:
a microprocessor for running software wherein the software analyzes the data from photodetectors and controls said remote gas molecule detector;
a gas molecule detector controller for transforming data between the gas molecule detector and the computer system; and
a storage device for storing predetermined diode laser pulsed current and analyzed data.

16. A computer system as recited in claim 15 wherein said gas molecule is alcohol.

17. A computer system as recited in claim 15 wherein said remote gas molecule detector further comprises:
an analog to digital converter for sampling inputs into digitized data for storage in said computer system wherein said digitized data will be analyzed according to an absorption band of said gas molecules; and
a digital to analog converter for converting stored data into continuous data, wherein the continuous data couples to an input of said remote gas molecule detector.

18. A gas molecule detector system with a remote gas molecule detector, said system comprising:
a gas molecule detector wherein said gas molecule to be detected is remote from the computer system;
a computer system for running a software wherein the software analyzes the data from photodetectors and controls said remote gas molecule detector; and
an interface connecting said computer system and said gas molecule detector.

19. A gas molecule detector system as recited in claim 18, wherein said interface comprises:
a diode laser supply transforming continuous diode laser current for remote gas molecule detector;
a resistance-voltage transformer providing good thermal contact with diode laser;
a peltier current supply providing power amplifier for pump current; and
photodetector transformer/amplifier unit for interfacing between a photodetector and a gas molecule controller.

20. The computer program product in a computer readable medium for a remote gas molecule detector comprising:
instructions for signal processing for generating diode laser current pulses;
instructions for stabilizing diode laser temperature wherein diode laser radiation is tunable by adjusting the temperature of said diode laser; and
instructions for calculating gas molecules concentration detected by said remote gas molecule detector.

21. The computer program product recited in claim 20, wherein said instructions for signal processing further comprises:
first instructions for setting pattern of current pulses;
second instructions for storing pattern in a buffer memory; and
third instructions for applying pattern to a digital to analog converter.

22. The computer program product recited in claim 21, wherein said current pulses is a high frequency square modulated with high amplitude.

23. The computer program product recited in claim 20, wherein said instructions for temperature stabilization further comprises:
first instructions for setting initial diode laser temperature by thermistor; and
second instructions for switching to line stabilization position.

24. The computer program product recited in claim 23, wherein said instructions for setting initial diode laser temperature by thermistor further comprises:
instructions for receiving resistance/voltage signal from said thermistor;
instructions for calculating actual said thermistor temperature;
instructions for calculating temperature difference between said actual temperature and set predetermine laser temperature; and
instructions for determining the pump current.

25. The computer program product recited in claim 23, wherein said instructions for switching to line stabilization position further comprises:
instructions for receiving sampled analytical photodetector signal;
instructions for separating each pulse according to a period;
instructions for subtracting zero signal from said sampled analytical photodetector signal wherein zero signal is an photodetector signal when said diode laser is switched off and wherein said instruction for subtracting zero signal lessens interference;
instructions for further dividing said separate pulse into an odd and even array;
instructions for calculating the logarithm of the ratio of respective even points in said even array over odd points in said odd array wherein low-frequency signal interference is removed;
instructions for mutual orthogonalizing the correlated factors of alcohol;
instructions for mutual orthogonalizing the correlated factors of water;
instructions for calculating correlation factor with alcohol function with orthogonalization of water; and
instructions for calculating correlation factor with water function with orthogonalization of alcohol.

26. The computer program product recited in claim 20, wherein said instructions for calculating gas molecule concentration further comprises:
first instructions for receiving sampled data from said remote gas molecule detector;
second instructions for checking and comparing said sampled data with predetermined fourier transform featuring absorption of said gas molecule and absorption a predetermined molecule content in a reference cell;
third instructions for producing distinctive channels;
fourth instructions for separating the channel containing the detected gas molecule according to discrete pulses of a diode laser current;
fifth instructions for generating an odd and even arrays from said gas molecule channel;
sixth instructions for subtracting zero signal from odd array;
seventh instructions for subtracting zero signal from even array;
eighth instructions for calculating the logarithm of even over odd ratio; and
ninth instruction for mutual orthogonalization of said gas molecule to be detected and content in the reference cell thereby, the concentration of gas molecule is calculated.

27. An apparatus for remotely detecting alcohol comprising:
a diode laser for emitting scanning radiation frequency at a maximum alcohol absorption band;
a first connector for a first current into the diode laser; and
a second connector for a second current adjusting the temperature of the diode laser.

28. An apparatus for remotely detecting alcohol comprising:
a diode laser for emitting radiation at a maximum alcohol absorption band wherein the radiation is tunable by adjusting the temperature of the diode laser;
an optical splitter receiving the emitted radiation and producing a first and second optical channels;
a first detector detecting the presence of a alcohol vapor from the first optical channel; and
a second detector for reference from the second optical channel.

29. An apparatus for remotely detecting alcohol comprising:
a diode laser for emitting radiation at a maximum alcohol absorption band wherein the radiation is tunable by adjusting the temperature of the diode laser;
an optical channel that pass through an enclosure to be detected of alcohol vapor twice, whereby the absorption of the alcohol vapor is amplified; and
a detector detecting the presence of a alcohol vapor from the optical channel.

30. An apparatus for remotely detecting a gas molecule comprising:
a diode laser for emitting radiation at a maximum absorption band if said gas molecule;
a single mode fiber coupling to the diode laser for diminishing of spatial inhomogenity of the radiation;
a first connection for a first current into the diode laser;
a second connection for a second current adjusting the temperature of the diode laser;
an optical splitter receiving the emitted radiation and producing a first and second optical channels;
a first detector detecting the presence of said gas molecule from the first optical channel; and
a second detector for reference from the second optical channel.
